(19) United States
(12) Patent Application Publication
(10) Pub. No.: US 2006/0259362 A1
(43) Pub. Date: Nov. 16, 2006

(54) System and Method for Combining Loyalty and Incentive Award Programs

(75) Inventor: Jeffery L. Cates, O'Fallon, MO (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: Meridian Enterprises Corporation, Hazelwood, MO (US)

(21) Appl. No.: 11/383,644

(22) Filed: May 16, 2006

Related U.S. Application Data
(60) Provisional application No. 60/681,363, filed on May 16, 2005.

(51) Int. Cl. G06Q 30/00

(52) U.S. Cl. 705/14

(57) ABSTRACT

A computer system and method is disclosed that combines the use of a loyalty award program with an incentive award program. The program participant uses a credit card to make purchases. The participant earns loyalty points based on the rules of the bank, such as for a specified percentage of the purchases. The participant thus earns incentive points based on the rules of a sponsor, such as for meeting certain personal sales or performance goals that are independent of purchases made with the credit card. Incentive points are converted to cash and used to pay down the card balance. Since incentive points pay down the card balance, the participant earns loyalty points without directly spending his/her own money. Loyalty points can be converted to incentive points and used to pay down the card balance, or loyalty points can be redeemed for merchandise or other items.

### CROSS-REFERENCE TO RELATED APPLICATIONS

The present application claims the benefit of U.S. Provisional Application Ser. No. 60/681,363 filed on May 16, 2005, which is hereby incorporated by reference in its entirety.

### BACKGROUND

The present invention relates to computer systems, and more particularly, but not exclusively, relates to loyalty and incentive award systems.

Today, there are various types of award programs in existence. Some award programs are based on the participant's loyalty or return business, and are called loyalty award programs. Other award programs are based on incentives or goals, and are called incentive award programs. These two types of award programs will now be described in further detail.

Loyalty award programs are offered by merchants, credit card companies, and various other types of companies to reward participants for their loyalty or business. Loyalty programs are commonly offered by merchants such as grocery stores, pharmacies, office supply stores, and the like to track the participant's spending with the respective company and then award the participant loyalty points or coupons based on the amount or number of purchases, for example. As another example, various credit card loyalty programs are offered by banks today that allow participants to earn cash back and/or other loyalty rewards for signing up for the credit card, for carrying a balance, for completing a transaction using the credit card, and/or for other loyalty-related activities. Such credit card loyalty programs typically allow the participant to redeem the loyalty points for merchandise, travel, gift cards, or they provide cash back at the end of a certain cycle. One shortcoming with loyalty award programs is that participants are not able to earn loyalty awards unless they spend their own money, for example, to purchase something.

Incentive award programs, while related in concept to loyalty award programs, are also quite different. With incentive award programs, an incentive award administrator company contracts with a sponsoring company to provide an incentive program to promote the sales of the sponsoring company's products or services, or to improve the performance of the sponsoring companies' personnel. The products or services promoted might be of a specific nature, such as a certain model product, or be broader, such as a full product line of the sponsor.

Participants in such incentive programs may comprise, for example, the sponsor's employees, the sponsor's customers and their employees, independent contractors for the company's products or services, or the end consumer who ultimately purchases the company's products or services.

Rules are established in order for the participants to earn awards under incentive programs. These rules vary depending upon what the sponsor hopes to achieve. Typically, with such programs, a certain objective or goal is established for each participant. These goals or objectives can vary depending upon the selection of the sponsoring company. The participant's goal may be based on a certain percentage increase over that participant's performance during the previous year, for example. Or the goal may be simply to buy or sell as many units of a certain product as possible, regardless of the previous year's or previous time period's performance.

One example of an incentive program award process involves the awarding of a certain number of points to the participant for the participant's purchasing or selling a designated dollar volume or quantity of products or services. If the participant accumulates a predesignated number of points during a certain time period, then the participant is enabled to acquire an award. In many cases, the value of the award or awards increases with the number of points accumulated. In one example, points earned may be converted to a dollar amount according to a formula. The dollars may then be used to purchase merchandise shown in the incentive company's catalog, or to earn a paid trip for the participant and perhaps a certain number of family members to a vacation spot such as Hawaii or Florida. In some cases, the points may be converted to a direct cash payment to the participant at either the. culmination of the period or the program.

More recently, incentive award programs have been introduced which utilize either a credit card or debit card which is issued to the participant. For example, one prior art program issues a traditional credit card to each incentive program participant. The participant's cardholder account is assigned a credit limit which is based, for example, upon the participant's past credit history. Award earnings which are accumulated in the incentive award program are then used to “float” this credit limit up to the level of the participant's assigned credit limit plus any available non-redeemed award earnings. The participant may then use the credit card to make purchases at any merchant honoring the credit card. These purchases will then reduce the amount of available credit on the cardholder account. After settlement and posting of these purchase transactions into the cardholder's account, the incentive program's administrator may make a payment to the cardholder's account based upon charge amounts and any available program earnings. The participant/cardholder is then responsible for any outstanding balances above the amount paid by the incentive program administrator. He may choose to pay this amount or allow the balance to revolve, thereby accruing interest charges until paid.

In a system as just described, points earned by the participant in the incentive program are not converted to dollars until purchases are posted to the cardholder's account. At that time, any available points are converted to dollars and the incentive program administrator makes a payment to the credit card issuer (i.e. the bank that issues the credit card). Under such a scenario, the incentive program administrator retains the money earned through the incentive program until such time as the program participant makes a purchase with his credit card.

As another example, an incentive award program may use either a debit card or a purchase card product. In some such systems, the card may be limited to a very select group of retailers and/or service providers. In one example, the incentive program administrator or the sponsor underwrites the credit liability and as a result is issued the master cardholder's account. Upon earning awards in the incentive program, the participant is then issued a sub-account of the master account. The spending limit is established as the participant's available earnings in the program. The participant may then use this limit to make purchases utilizing the card. These purchases will then reduce the spending limit on the cardholder's sub-account. The incentive program administrator will then make a payment to the master account based upon charge amounts from all sub-accounts in a cycle period after settlement and posting of the purchase transactions into the master account. There is a post-reconciliation process where the sub-account charges are then applied to downgrade the available earnings associated with each particular sub-account and to reestablish a sub-account spending limit based upon the remaining available earnings.

While there has been use of both loyalty award programs and incentive award programs as separate programs, advantages of integrating these programs together have not been realized. The present disclosure is directed toward meeting these and other needs.

### SUMMARY

One form of the present disclosure is a computer system. Other forms include unique systems and methods for combining loyalty and incentive award programs.

In one aspect of the disclosure, a system and method is disclosed that includes a loyalty award program and an incentive award program. A credit card provider, such as a bank, offers a loyalty program to the participant that is related to use of the credit card. An incentive program administrator administers for a sponsor an incentive program that is associated with the same credit card provided to the participant by the credit card provider. Once loyalty points have been earned, the purchaser can decide whether to redeem the points for merchandise or other items, or whether to convert the loyalty points to incentive points so the converted loyalty points can be used to pay down the credit balance. Once incentive points are earned, the incentive points are applied as payment towards the credit balance on the participant's credit card.

In another aspect of the disclosure, a computer system and method is disclosed that combines the use of a loyalty award program with an incentive award program for a single credit card account. The participant uses the credit card to make one or more purchases. The participant earns loyalty points based on loyalty rules of the bank, such as based upon a specified percentage of the purchases. The participant also earns incentive points based on the program rules of the sponsor, such as for meeting certain personal sales or performance goals that are independent of any purchases made with the credit card. Incentive points are converted to cash and used to pay down the balance on the card. Since incentive points pay down the card balance, the participant is effectively earning a certain amount of loyalty points without spending his/her own money. Furthermore, loyalty points can be converted to incentive points and used to pay down the balance on the credit card, or the loyalty points can just be redeemed for merchandise or other items.

In yet another aspect of the disclosure, an integrated loyalty and incentive award system is disclosed which comprises: a transaction device associated with at least one account; an incentive award program associated with said at least one account, said incentive award program providing incentive credits to said at least one account in accordance with one or more rules of said incentive award program; a loyalty award program associated with said at least one account, said loyalty award program providing loyalty credits to said at least one account in response to the use of said transaction device; wherein the use of said transaction device in response to said incentive credits provided to said at least one account by said incentive award program causes loyalty credits to be provided to said at least one account by said loyalty award program.

Additional embodiments of the integrated loyalty and incentive award system detailed above are disclosed which may be further modified in one or more of the following ways such that: said at least one account is a credit card account; a credit limit of said credit card account is based upon the credit history of the owner of said credit card account; a credit limit of said credit card account is based upon the credit history of the owner of said credit card account; said credit limit is increased by an amount representative of said incentive credits provided in accordance with said incentive award program; said at least one account is a debit card account; said incentive credits provided in accordance with said incentive award program are applied as monetary credits to said at least one account; said incentive credits provided in accordance with said incentive award program are applied as monetary credits to said at least one account only when said account reflects an amount owed; activity which results in providing incentive credits to said at least one account by said incentive award program does not directly result in providing loyalty credits to said at least one account by said loyalty award program; activity which results in providing loyalty credits to said at least one account by said loyalty award program does not directly result in providing incentive credits to said at least one account by said incentive award program; said incentive credits provided in accordance with said incentive award program are applied as monetary credits to said account such that the balance amount of said account being offset by said monetary credits generates loyalty credits in accordance with said loyalty award program; said loyalty credits are convertible to incentive credits; a bank administers said loyalty award program, said bank also administering said at least one account; said transaction device comprises a credit card; said transaction device comprises a debit card; said transaction device comprises a radio frequency identification (rfid) tag; and said transaction device comprises a bar-coded card.

Furthermore, yet another embodiment of the integrated loyalty and incentive award system detailed above is disclose which also includes a single enrollment form which is processed to associate said at least one account with both said loyalty award program and said incentive award program.

In still another form of the disclosure, a method for integrating a loyalty award program with an incentive award program is disclosed which comprises the steps of: providing a transaction device associated with a monetary account, an incentive point account, and a loyalty point account; providing a point credit to said loyalty point account in response to the use of said transaction device; providing a point credit to said incentive point account in response to actions in accordance with said incentive award program; providing monetary credits to said monetary account proportionate to the balance of said incentive point account; and generating loyalty point credits in response to the application of said monetary credits to said monetary account.

Additional embodiments of the method for integrating a loyalty award program with an incentive award program detailed above are disclosed which may be further modified in one or more of the following ways such that: said application of said monetary credits comprises making a purchase; said application of said monetary credits comprises paying at least a portion of the balance of said monetary account; said loyalty point account credits may be converted into incentive point account credits; said loyalty point account credits can be redeemed for a benefit in accordance with said loyalty award program; said monetary account is a credit card account with a credit limit based upon the credit history of the owner of said monetary account; said transaction device is a credit card; said transaction device is a debit card; said transaction device is a radio frequency identification (rfid) tag; and said transaction device is a bar-coded card.

Furthermore, additional embodiments of the method for integrating a loyalty award program with an incentive award program detail above are disclosed which may further include the steps of: increasing said credit limit of said monetary account by an amount proportionate to the balance of said incentive point account; and using a single enrollment form to associate said monetary account with both said loyalty point account and said incentive point account.

In yet another form of the disclosure, a method for integrating a loyalty award program with an incentive award program is disclosed which comprises the steps of: providing a transaction device associated with a monetary account, an incentive point account, and a loyalty point account; providing incentive point credits to said incentive point account in response to actions in accordance with said incentive award program; and providing loyalty point credits to said loyalty point account in response to the use of said transaction device.

Additional embodiments of the method for integrating a loyalty award program with an incentive award program as disclosed above are disclosed which may further comprises the steps of: providing monetary credits to said monetary account representative of the balance of said incentive point account; and providing loyalty point credits to said loyalty point account in response to the providing of monetary credits to said monetary account.

Further forms, embodiments, objects, advantages, benefits, features, and aspects of the present disclsoure will become apparent from the detailed description and drawings contained herein.

### BRIEF DESCRIPTION OF THE DRAWINGS

FIG. 1 is a diagrammatic view of a computer system of one embodiment of the disclosure.

FIG. 2 is a data flow diagram for the system of FIG. 1 demonstrating the flow of data between the incentive and loyalty award processes.

FIGS. 3a and 3b are a process flow diagram for the system of FIG. 1 demonstrating the stages involved in combining incentive award programs and loyalty award programs.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

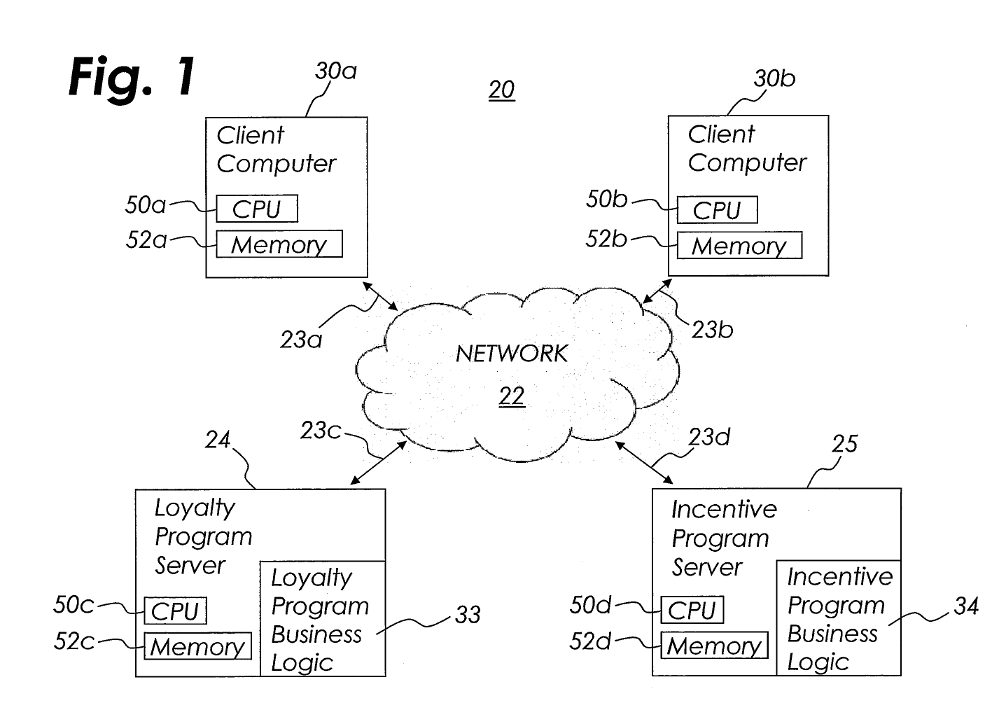

FIG. 1 is a diagrammatic view of an integrated loyalty and incentive award system implemented in computer system 20 in accordance with one embodiment of the present disclosure. Computer system 20 includes computer network 22. Computer network 22 couples together a number of computers over network pathways 23a-d. System 20 includes multiple servers, namely Loyalty Program Server 24 and Incentive Program Server 25. System 20 also is shown as including client computers 30a and 30b (collectively 30). While computers 24, 25, and 30 are each illustrated as being a server or client computer, it should be understood that any of computers 24, 25, and 30 may be arranged to include both a client and server functionality. Furthermore, it should be understood that while four computers 24, 25, 30a and 30b are illustrated, more or fewer may be utilized in alternative embodiments.

Computers 24, 25, 30a and 30b include one or more processors or CPUs (50a, 50b, 50c, and 50d, respectively) and one or more types of memory (52a, 52b, 52c, and 52d, respectively). Although not shown to preserve clarity, each memory 52a, 52b, 52c, and 52d may include a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III® or PENTIUM 4® processors supplied by INTEL® Corporation of 2200 Mission College Boulevard, Santa Clara, Calif. 95052, USA.

Each memory (removable or generic) is one form of a computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display. Computers 24, 25, and 30 may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Also, besides a display, one or more other output devices may be included such as loudspeaker(s) and/or a printer. Various display and input device arrangements are possible.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations to provide an integrated loyalty and incentive award program. In one embodiment, Loyalty Program Server 24 is configured to host business logic 33 for administrating the loyalty award program, and Incentive Program Server 25 is configured to host business logic 34 for administrating the incentive award program. The two processes are shown as being operable to communicate with one another over network 22. In one embodiment, client computers 30a-30b are configured for allowing a user to access loyalty program business logic 33 of Loyalty Program Server 24 and/or incentive program business logic 34 of Incentive Program Server 25. As a few non-limiting examples, client computers 30a-30b could be used by a participant to view/manage his loyalty and/or incentive program details, client computers 30a-30b could be used by a bank or other designated party to administer the loyalty program, and/or client computers 30a-30b could be used by an incentive program administrator or other designated party to administer the incentive program. One of ordinary skill in the software art will appreciate that user interfaces on client computers 30a-30b, loyalty program business logic 33, and incentive program business logic 34 can be hosted on one or more computers in a thin client or thick client architecture, for example. In one embodiment, Loyalty Program Server 24 is located in a different physical location than Incentive Program Server 25. In another embodiment, Loyalty Program Server 24 is located in the same physical location as Incentive Program Server 25. In one embodiment, Loyalty Program Server 24 is under the control of a credit card provider or designated representative, and Incentive Program Server 25 is under the control of an incentive award program administrator or designated representative. Other variations are also possible, as would occur to one of skill in the art.

Typical applications of system 20 would include more or fewer client computers of this type at one or more physical locations, but two have been illustrated in FIG. 1 to preserve clarity. Furthermore, although two servers are shown, it will be appreciated by those of ordinary skill in the art that the one or more features provided by Loyalty Program Server 24 and Incentive Program Server 25 could be provided on the same computer or varying other arrangements of computers at one or more physical locations and still be within the spirit of the invention. Farms of dedicated servers could also be provided to support the specific features if desired.

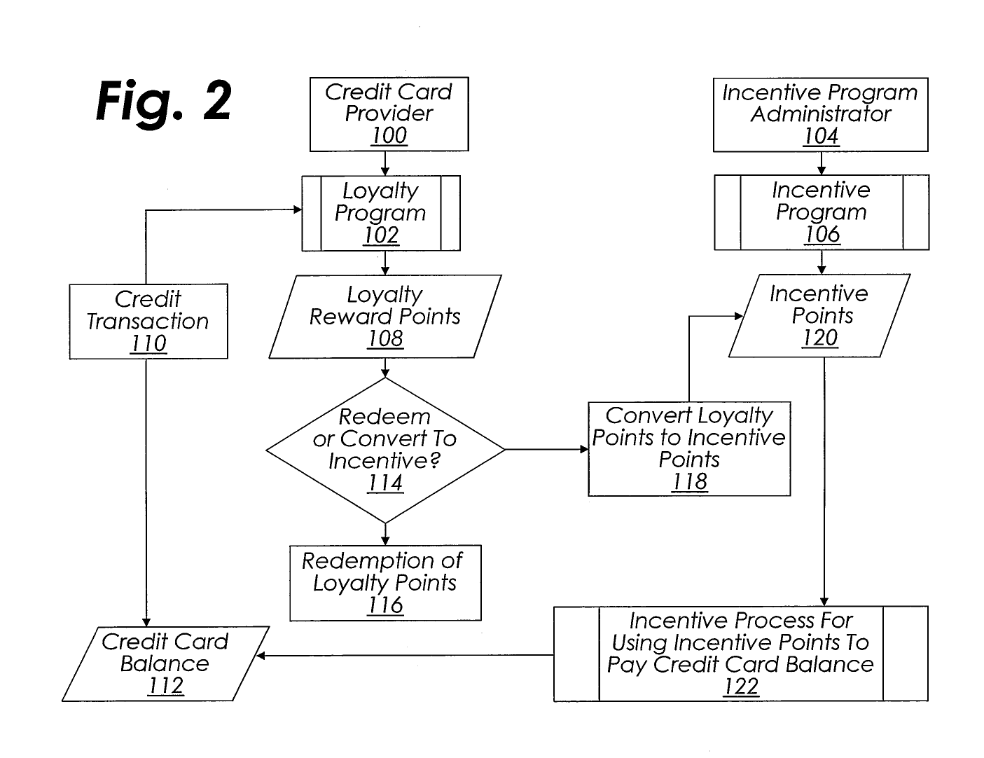

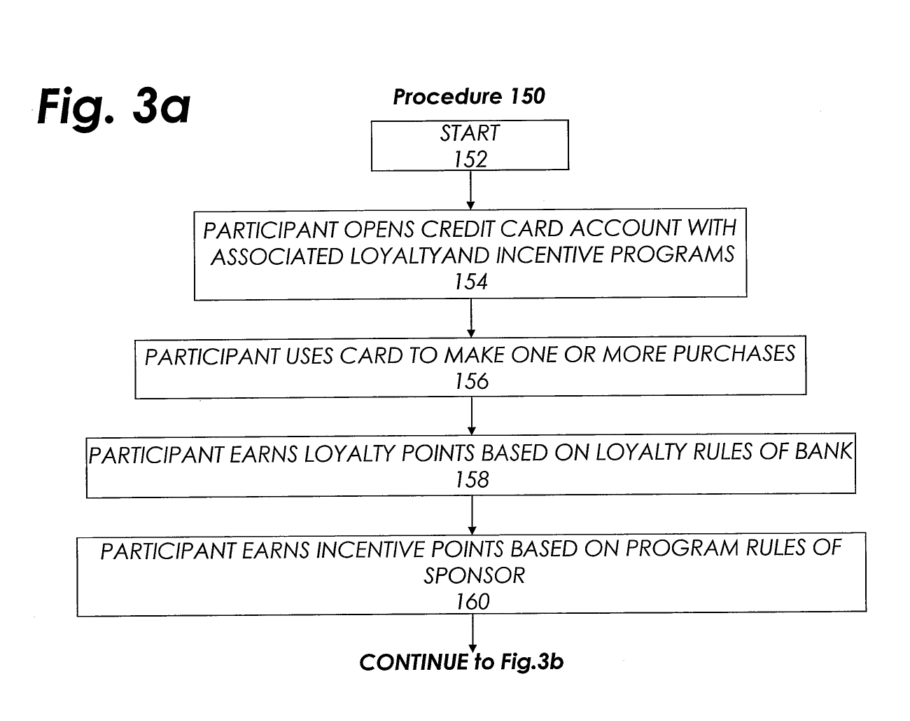

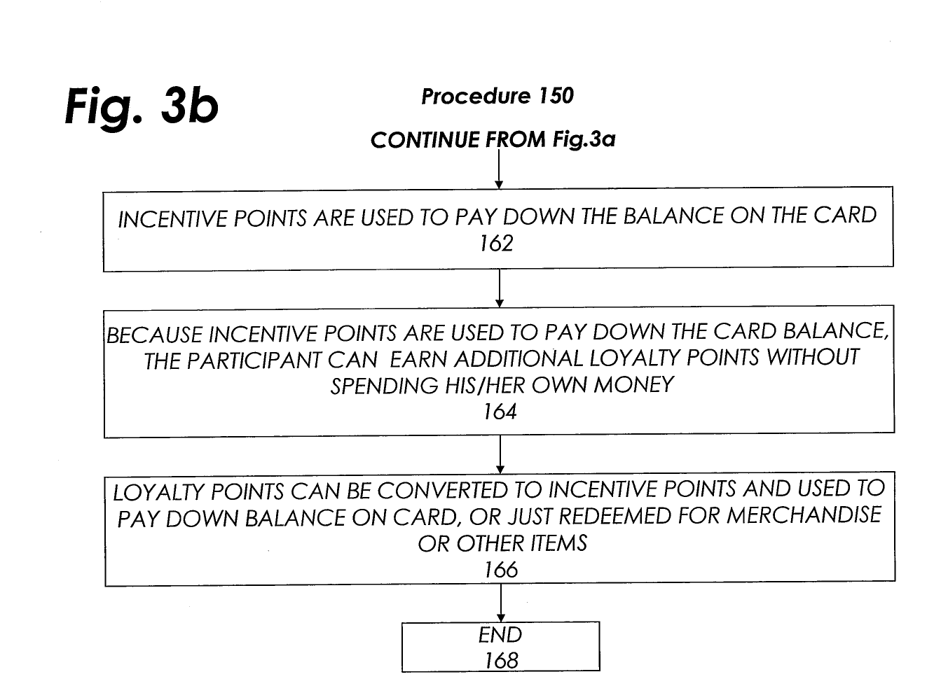

Referring additionally to FIG. 2, a data flow diagram illustrates the high level flow of data through the processes of system 20. The details of the stages involved in these processes will also be described in greater detail with respect to FIG. 3. In the illustrated example of FIG. 2, Credit Card Provider 100 offers a loyalty program 102 for use with a credit card. Other types of customer devices, such as debit cards and rfid tags, may also be used, for example. Incentive Program Administrator 104 administers for a sponsor an incentive program 106 that can be associated with the same credit card or other devices provided by Credit Card Provider 100.

Through participation in the loyalty program 102, the participant can earn loyalty reward points 108 that are placed in a loyalty point account. Loyalty reward points 108 can be earned from a credit transaction 110 when the participant uses the card to make a purchase, or by some other activity in the loyalty program rules that earns points. As a few non-limiting examples, loyalty points can be calculated based on a sign-up bonus, revolving balance, activity, or transaction. Credit transactions 110 made by the purchaser increase the credit card balance 112 on the credit card. Once loyalty points 108 have been earned, the purchaser can decide (decision point 114) whether to redeem the points for merchandise, travel, gift cards, cash rebates, etc. 116 or whether to convert the loyalty points to incentive points 118 so the converted loyalty points can be used to pay down the credit card balance 112.

Also as shown in FIG. 2, through participation in the incentive program 106, the participant earns incentive points 120 based on the incentive program rules of the program sponsor. For example, if the incentive program is designed to reward employees based upon a percentage of sales made, then a particular employee may earn incentive points based on the percentage of sales he made in a designated period of time, for example. Incentive program 106 may be a substitute for a monetary bonus system in which, instead of issuing a check, incentive points 120 are awarded and placed in an incentive point account. Upon earning incentive points 120, the incentive process 122 uses the points as payment towards the credit card balance 112 on the participant's credit card (the same card that is also earning loyalty points). By integrating the loyalty award program and incentive award program with a single card, the participant is also able to earn loyalty points without directly spending his own money, as will be described in greater detail in FIGS. 3a and 3b.

Referring additionally to FIGS. 3a and 3b, procedure 150, as illustrated, shows stages involved in administering an integrated incentive and loyalty award program with a single card in accordance with an embodiment of the disclosure. In the embodiment shown, procedure 150 is at least partially implemented in the operating logic of system 20. Procedure 150 begins at start point 152 with participant opening a credit card account that has both a loyalty program and an incentive program associated with it (stage 154). Both programs can become associated with the credit card with the processing of a single enrollment form, or two or more separate enrollment forms may be processed. Once the credit card account is opened, the participant can use the credit card to make one or more purchases (stage 156) at any merchant that accepts that type of credit card.

The participant can earn loyalty points based on loyalty rules of the bank or other credit card provider (stage 158), such as for a bonus for opening the new credit card account and/or based on usage of the credit card, as a few examples. In one embodiment, loyalty points are calculated as one loyalty point for every one dollar spent, or one loyalty point for every transaction processed, to name a few non-limiting examples. Numerous other variations are also possible for determining points.

The participant can also earn incentive points based on the program rules of the sponsor (stage 160). For example, the sponsor may provide incentives to reward employees, contractors, or customers for certain behaviors, such as bonuses for achieving a certain sales or performance level, to name a few non-limiting examples. As part of the incentive process 122 that is administered by the Incentive Program Administrator 104, the incentive points are converted to money and used to pay down the balance on the credit card (stage 162). Alternatively, the incentive points are converted to money and used to fund a debit card account. The Incentive Program Administrator 104 makes a payment to the credit card account or debit card provider after converting the points to money.

Incentive program 106 and loyalty program 102 are not required to be associated with each other and the earning of loyalty points and incentive points may be entirely independent of each other. Incentive program 106 may be administered by an employer while loyalty program 102 may be administered by the issuer or underwriter of the card. Incentive program 106 is preferably designed to reward and encourage behavior by the employer's employees that the employer wants to encourage wherein loyalty program 102 is preferably designed to encourage usage of the card which is beneficial to the issuer or underwriter of the card such as carrying a revolving credit balance or making a purchase with the card that generates transaction fees. However, it is also contemplated that the administrator of incentive program 106 could also administer loyalty program 102, such as when the administrator is a bank. In that case, the bank may want to reward its employees for say, writing a large number of loans, through incentive program 106 while also rewarding the use of its credit card with loyalty program 102.

Because incentive points may be used to pay down the credit card balance or fund a debit card, the participant can actually earn a certain amount of loyalty points without directly spending his/her own money (stage 164). Here is a hypothetical example to better illustrate how this works. Suppose the participant purchased some flowers using the credit card from a florist. The participant also met his quarterly sales quota at his place of employment and qualifies for incentive awards based on this accomplishment (which is totally separate from the fact that he purchased some flowers using the credit card). When the participant receives incentive points as a reward for meeting the sales quota, which was the behavior being encouraged by the sponsor, the incentive points are used to pay down the credit card balance that just occurred because of the purchase of the flowers. By making the purchase of the flowers, the participant also earned loyalty points from the credit card provider for the purchase, even though in the end the participant will not have to spend all or part of his own money out of pocket to pay for the transaction.

As another example, suppose the participant has no balance on his credit card. He earns $500 through his participation in the incentive program, and this amount is awarded to his credit card. The participant then uses the credit card to buy a $500 television. The $500 purchase earns 1% cash back. under the loyalty program. The incentive award pays for the $500 purchase. The participant therefore earns $5 in loyalty awards without spending any of his own money beyond that awarded through the incentive program. The issuing bank is pleased because the incentive award has resulted in a $500 transaction on their card, which generates fees from the merchant who sold the television. The incentive award sponsor is pleased, because the addition of the loyalty award enhances the perceived value of the incentive program without costing the sponsor anything. The participant is pleased because he earned an extra $5 in loyalty awards without having to spend any additional amount of his own money.

As yet another example, in one embodiment of this combined system, the loyalty program may reward the participant upon the deposit of incentive points in the participant's account, regardless of how those points are eventually used or spent by the participate.

In addition, the participant can choose to have his loyalty points converted to incentive points and used to pay down the balance on the credit card, or the participant can just redeem the loyalty points for merchandise, travel, gift cards, gift certificates, cash rebates, etc. (stage 166). Procedure 150 then ends at end point 168.

One of ordinary skill in the art will appreciate that while the term credit card is used in the examples herein for purposes of illustration, other types of instruments such as debit cards, could also be used with the system and methods discussed herein and still be in the spirit of the invention.

One of ordinary skill in the computer software art will also appreciate that the functionality, processes, and/or components described herein can be separated or combined on one or more computers or screens in various arrangements and still be within the spirit of the invention.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

What is claimed:

1. An integrated loyalty and incentive award system comprising:
a transaction device associated with at least one account;
an incentive award program associated with said at least one account, said incentive award program providing incentive credits to said at least one account in accordance with one or more rules of said incentive award program;
a loyalty award program associated with said at least one account, said loyalty award program providing loyalty credits to said at least one account in response to the use of said transaction device;
wherein the use of said transaction device in response to said incentive credits provided to said at least one account by said incentive award program causes loyalty credits to be provided to said at least one account by said loyalty award program.

2. The integrated loyalty and incentive award system of claim 1, wherein said at least one account is a credit card account.

3. The integrated loyalty and incentive award system of claim 2, wherein a credit limit of said credit card account is based upon the credit history of the owner of said credit card account.

4. The integrated loyalty and incentive award system of claim 3, wherein said credit limit is increased by an amount representative of said incentive credits provided in accordance with said incentive award program.

5. The integrated loyalty and incentive award system of claim 1, wherein said at least one account is a debit card account.

6. The integrated loyalty and incentive award system of claim 1, wherein said incentive credits provided in accordance with said incentive award program are applied as monetary credits to said at least one account.

7. The integrated loyalty and incentive award system of claim 1, wherein said incentive credits provided in accordance with said incentive award program are applied as monetary credits to said at least one account only when said account reflects an amount owed.

8. The integrated loyalty and incentive award system of claim 1, wherein activity which results in providing incentive credits to said at least one account by said incentive award program does not directly result in providing loyalty credits to said at least one account by said loyalty award program.

9. The integrated loyalty and incentive award system of claim 1, wherein activity which results in providing loyalty credits to said at least one account by said loyalty award program does not directly result in providing incentive credits to said at least one account by said incentive award program.

10. The integrated loyalty and incentive award system of claim 1, wherein said incentive credits provided in accordance with said incentive award program are applied as monetary credits to said account such that the balance amount of said account being offset by said monetary credits generates loyalty credits in accordance with said loyalty award program.

11. The integrated loyalty and incentive award system of claim 1, further comprising a single enrollment form which is processed to associate said at least one account with both said loyalty award program and said incentive award program.

12. The integrated loyalty and incentive award system of claim 1, wherein said loyalty credits are convertible to incentive credits.

13. The integrated loyalty and incentive award system of claim 1, wherein a bank administers said loyalty award program, said bank also administering said at least one account.

14. The integrated loyalty and incentive award system of claim 1, wherein said transaction device comprises a credit card.

15. The integrated loyalty and incentive award system of claim 1, wherein said transaction device comprises a debit card.

16. The integrated loyalty and incentive award system of claim 1, wherein said transaction device comprises a radio frequency identification (rfid) tag.

17. The integrated loyalty and incentive award system of claim 1, wherein said transaction device comprises a bar-coded card.

18. A method for integrating a loyalty award program with an incentive award program comprising the steps of:
providing a transaction device associated with a monetary account, an incentive point account, and a loyalty point account;
providing a point credit to said loyalty point account in response to the use of said transaction device;
providing a point credit to said incentive point account in response to actions in accordance with said incentive award program;
providing monetary credits to said monetary account proportionate to the balance of said incentive point account; and
generating loyalty point credits in response to the application of said monetary credits to said monetary account.

19. The method of claim 18, wherein said application of said monetary credits comprises making a purchase.

20. The method of claim 18, wherein said application of said monetary credits comprises paying at least a portion of the balance of said monetary account.

21. The method of claim 18, wherein said loyalty point account credits may be converted into incentive point account credits.

22. The method of claim 18, wherein said loyalty point account credits can be redeemed for a benefit in accordance with said loyalty award program.

23. The method of claim 18, wherein said monetary account is a credit card account with a credit limit based upon the credit history of the owner of said monetary account.

24. The method of claim 23, further comprising the step of:
increasing said credit limit of said monetary account by an amount proportionate to the balance of said incentive point account.

25. The method of claim 18, wherein said transaction device is a credit card.

26. The method of claim 18, wherein said transaction device is a debit card.

27. The method of claim 18, wherein said transaction device is a radio frequency identification (rfid) tag.

28. The method of claim 18, wherein said transaction device is a bar-coded card.

29. The method of claim 18, further comprising the step of:
using a single enrollment form to associate said monetary account with both said loyalty point account and said incentive point account.

30. A method for integrating a loyalty award program with an incentive award program comprising the steps of:
providing a transaction device associated with a monetary account, an incentive point account, and a loyalty point account;
providing incentive point credits to said incentive point account in response to actions in accordance with said incentive award program; and
providing loyalty point credits to said loyalty point account in response to the use of said transaction device.

31. The method of claim 39, further comprising the step of:
providing monetary credits to said monetary account representative of the balance of said incentive point account.

32. The method of claim 31, further comprising the step of:
providing loyalty point credits to said loyalty point account in response to the providing of monetary credits to said monetary account.
